(19) United States
(12) Patent Application Publication
(10) Pub. No.: US 2011/0127299 A1
(43) Pub. Date: Jun. 2, 2011

(54) DISPENSER FOR SPREADABLE FOOD

(76) Inventor: Daniel Jeffery Calkins, Perry, MI (US)

(21) Appl. No.: 12/628,480

(22) Filed: Dec. 1, 2009

(51) Int. Cl. G01F 11/00

(52) U.S. Cl. 222/390

(57) ABSTRACT

A spreadable food dispensing package is disclosed. An indexed movable wall has a raised portion which extends from an upper surface of the indexed movable wall toward a first end of the dispensing package. As a base is rotated relative to the dispensing package, an indexing mechanism is moved which causes the indexed movable wall to move from a first position proximate the base to a second position which is spaced from the base and from the first end of the dispensing package. This movement causes the raised portion to cooperate with a side wall of the dispensing package to remove the spreadable food from the side wall. The movement also forces the spreadable food to be moved toward the first end of the dispensing package to allow a consumer to easily remove the spreadable food from the dispensing package with a utensil.

### FIELD OF THE INVENTION

The present invention relates to a device for storing and dispensing food products. In particular, the present invention is directed to a device which has a movable surface.

### BACKGROUND OF THE INVENTION

Traditionally, conventional storage for spreadable food has involved the use of glass, plastic and metal containers such as jars and cans. One problem associated with these traditional containers is that when the item being stored in the container, such as peanut butter, mayonnaise, etc., is running low, reaching the bottom of the jar with a knife or spoon or other device becomes difficult. This is not efficient and can cause messes and spills.

Attempts to provide improved food dispensers have been described in various patents and patent applications. US 2008/0121665 discloses a dispenser for spreadable foodstuffs or spreadable non-food substances which allows for the spreading without the need for additional utensils that are not part of the packaging. The dispenser can be easily refilled with replaceable cartridges and is designed to keep food away from air as contents are dispensed. While this type of dispenser may work with some types of food, it is not practical to use when the food does not flow easily. This type of dispenser does not allow the user to position a knife or other utensil in the food chamber and remove the food without interference.

UK Patent Application 2 304 815 discloses a dispenser for soft butter, etc. which has an outer molding which is internally screw-threaded and of which a bottom end portion is seated in a base cup. An inner molding forms a sleeve within the outer molding; a bottom end of the sleeve is secured to a floor of the base cup. A plunger is accommodated within the sleeve to act as a piston for dispensing butter from a collapsible container within the sleeve. The butter is discharged through an orifice in a top piece. By rotating the outer molding relative to the base cup, the plunger can be driven through the sleeve. The rotation of the plunger relative to the base cup is prevented by the engagement of the plunger lugs in the slots of the sleeve. While this design is suitable for soft food spreads, the lugs of the plunger must engage the screw-threaded internal surface of the outer molding to operate properly. This prevents the plunger from making a tight seal against the internal surface of the outer molding, which can allow the food to leak out of the container.

It would, therefore, be beneficial to provide a storage and dispensing container for food which would allow the user to properly advance the food toward a top surface with minimal loss and which would allow the user to insert a utensil into the food chamber without restriction.

### SUMMARY OF THE INVENTION

One aspect of the invention is directed to a spreadable food dispensing package which has a container body, a base, an indexing mechanism and an indexed movable wall. The spreadable food is provided in the container body. The container body has a first end with an opening through which the spreadable food is removed. The base is attached to the container body and is rotatable relative to the container body. The indexing mechanism is attached to the base and extends from the base toward the first end of the container body. The indexed movable wall cooperates with the indexing mechanism. As the base is rotated relative to the container body, the indexing mechanism is moved, causing the indexed movable wall to move from a first position proximate the base to a second position which is spaced from the base and from the first end of the container body. This forces the spreadable food to be moved toward the first end of the container body to allow a consumer to easily remove the spreadable food from the container body with a utensil.

Another aspect of the invention is directed to a spreadable food dispensing package which has a container body, a base, an indexing mechanism and an indexed movable wall. The spreadable food is provided in the container body. The container body has a first end with an opening through which the spreadable food is removed. The base is attached to the container body and is rotatable relative to the container body. The indexing mechanism is attached to the base and extends from the base toward the first end of the container body. The indexed movable wall, which cooperates with the indexing mechanism, has a raised portion which extends from an upper surface of the indexed movable wall toward the first end of the container body. The raised portion is positioned proximate the periphery of the indexed movable wall. As the indexed movable wall is moved from a first position proximate the base to a second position which is spaced from the base, the raised portion cooperates with a side wall of the container portion to remove the spreadable food from the side wall.

Another aspect of the invention is directed to a spreadable food dispensing package which has a container body, a base, an indexing mechanism and an indexed movable wall. The spreadable food is provided in the container body. The container body has a first end with an opening through which the spreadable food is removed. The base is attached to the container body and is rotatable relative to the container body. The indexing mechanism is attached to the base and extends from the base toward the first end of the container body. The indexed movable wall, which cooperates with the indexing mechanism, has a raised portion which extends from an upper surface of the indexed movable wall toward the first end of the container body. As the base is rotated relative to the container body, the indexing mechanism is moved, which causes the indexed movable wall to move from a first position proximate the base to a second position which is spaced from the base and from the first end of the container body. This movement causes the raised portion to cooperate with a side wall of the container portion to remove the spreadable food from the side wall. The movement also forces the spreadable food to be moved toward the first end of the container body to allow a consumer to easily remove the spreadable food from the container body with a utensil.

Advantages of the invention include, but are not limited to, allowing access to the food without causing the user's hand to be dirtied and causing contamination to the spreadable food. As spreadable food is removed from the container or dispensing package, the consumer turns the base to advance the movable indexed wall and the spreadable food toward a first end of the container body. This allows the spreadable food always to be provided proximate the first end of the dispensing package. In particular, the spreadable food is always positioned within reach of a knife blade inserted into the dispensing package. This allows the handle of the knife and the user's hand to be positioned outside of the dispensing package. Consequently, the user's hand will not make contact with the spreadable food in the container, thereby keeping the user's hand clean and preventing germs from the user's hand from contaminating the spreadable food in the container.

The use of the indexing member which protrudes only partially into the dispensing package is beneficial. As the indexing member does not protrude into the area of the dispensing package into which the user properly inserts only the blade of the knife and not the handle, no part of the indexing mechanism will be contacted by the knife. If the indexing member extended further toward the first end of the dispensing package, the indexing member would interfere with the user's dispensing the spreadable food with his/her knife. Therefore, in order to allow the user to properly access the spreadable food, the indexing member cannot extend to proximate the first end of the dispensing package. The purpose of this container is not to dispense the spreadable food directly from the container to a food product; it is to move the spreadable food toward the first end of the dispensing package so that the user can easily and neatly access the spreadable food with a knife or other utensil.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of the present dispensing package.

FIG. 2 is a cross-sectional view of the dispensing package of FIG. 1 showing the motion of an indexed movable wall relative to the motion of a base of an indexing mechanism.

FIG. 4 is a side view of the container body of the dispensing package.

FIG. 3 is a top view of a container body of the dispensing package.

FIG. 6 is a cross-sectional view of the indexed movable wall of the dispensing package.

FIG. 5 is a top view of the indexed movable wall of the dispensing package.

FIG. 8 is a side view of the indexing mechanism of the dispensing package.

FIG. 7 is a top view of the indexing mechanism of the dispensing package.

### DETAILED DESCRIPTION OF THE INVENTION

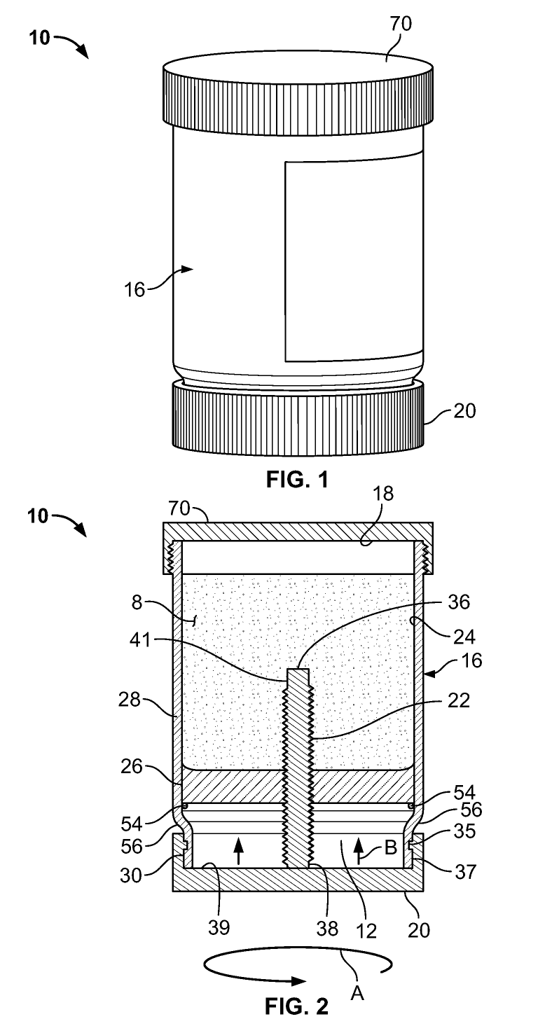

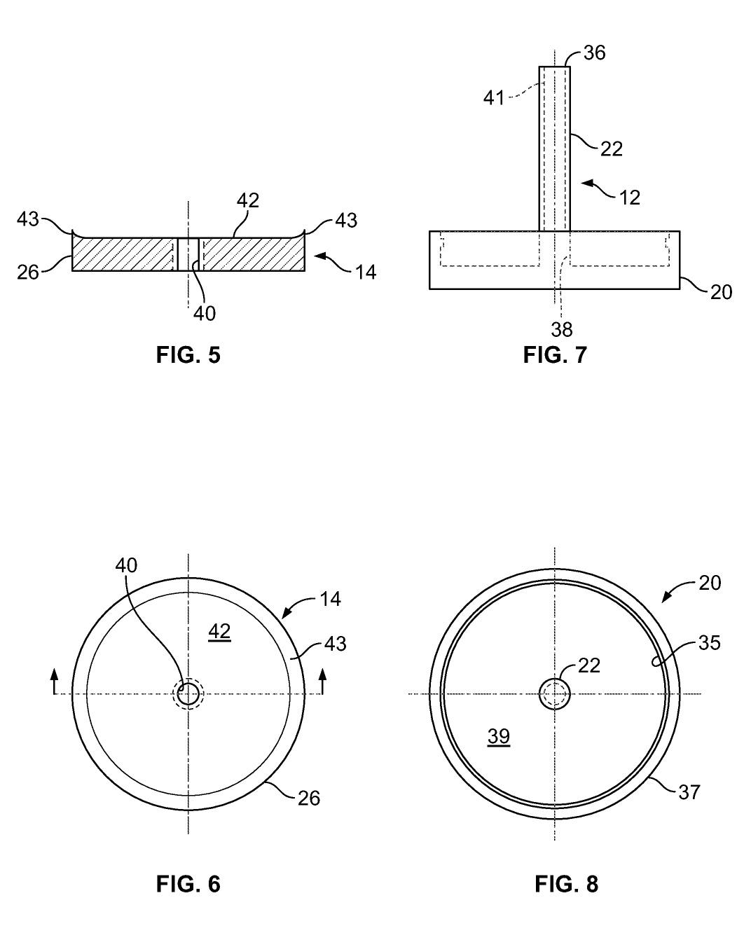

With reference to FIGS. 1 through 8, a food dispensing package 10 is disclosed. The dispensing package 10 employs a base 20 attached to an indexing mechanism 12 to move an indexed movable wall 14 within a container body 16 and force spreadable food or other material toward the first end 18 of the container body 16. Spreadable foods 8 may include, but are not limited to, peanut butter, jelly, mayonnaise and the like.

In accordance with the preferred embodiment of the present invention, the dispensing package 10 includes the container body 16 in which the spreadable food 8 is stored, the indexed movable wall 14 used to force the spreadable food 8 within the container body 16 toward the first end 18 of the container body 16, and the indexing mechanism 12 controlling the movement of the indexed movable wall 14 within the container body 16. The container body 16 is preferably constructed from plastic, glass or other material which exhibits the strength and surface smoothness to allow for a smooth sliding interaction between an inner wall 24 of the container body 16 and an outer wall 26 of the indexed movable wall 14.

With reference to FIGS. 1 through 4, the container body 16 is commonly cylindrical in shape, although other shapes could be employed without departing from the spirit of the present invention. Container body 16 includes a first end 18 through which the spreadable food 8 is dispensed, elongated side wall 28, and a second end 30 which cooperates with the base 20, as will be more fully described. A recess 34 (FIG. 3) is provided in an external surface of the side wall 28 proximate the second end 30 of the container body 16.

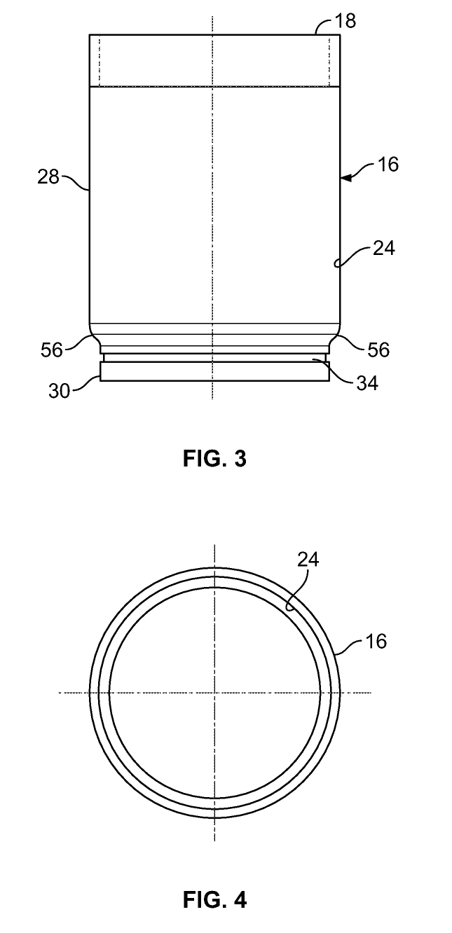

As shown in FIGS. 2, 7 and 8, the indexing mechanism 12 includes a threaded post 22 which is secured to the rotatable base 20 for rotation therewith. In the embodiment shown, the base 20 and indexing mechanism 12 are molded in a unitary piece, but the base 20 and the indexing mechanism 12 may be separate pieces which are affixed using common techniques.

The base 20 has a side wall 37 which extends about the circumference of an indexing mechanism receiving wall 39. The side wall 37 is shown to be essentially perpendicular to the receiving wall 39, but other configurations can be used. A projection 35 extends from an inside surface of the side wall 37. The projection 35 may be one continuous member which extends about the entire inside surface (or a majority thereof) or may be fragmented pieces located periodically about the inside surface. As the base 20 is inserted onto the container body 16 over the second end 30, the projection 35 engages the side wall 28 proximate the second end 30, causing the side wall 37 of the base 20 to be resiliently displaced away from the side wall 28 of the container body 16. As the projection 35 reaches the recess 34, the side wall 37 is allowed to return to its unstressed position, causing the projection 35 to be moved into and retained in the recess 34. In this position, the projection 35 is maintained in the recess 34, while permitting a user to engage and rotate the base 20 when the user desires to dispense the spreadable food 8. Other means of retaining the base 20 while allowing the base 20 to rotate relative to the container body 16 may be used without departing from the scope of the invention.

The indexing mechanism 12 has a first end 36 and a second end 38. The second end 38 of the indexing mechanism 12 extends through the second end 30 of the container body 16 and is coupled to the base 20. In this way, the indexing mechanism 12 is rotated when the base 20 is rotated by a user. The first end 36 of the indexing mechanism 12 extends within the container body 16 such that the indexed movable wall 14 may cooperate with the indexing mechanism 12 to move the indexed movable wall from a first position proximate the base 20 to a second position which is spaced from the base 20 and from the first end 18 of the container body 16.

As best shown in FIG. 2, the indexing mechanism 12 does not extend to the first end 18 of the container body 16. In the embodiment shown, the first end 36 of the indexing mechanism 12 extends approximately half of the distance into the container body 16 as measured from the second end 30. While the height of the indexing mechanism can vary without departing from the scope of the invention, the height of the indexing mechanism 12 is always less than the height of the container body 16.

The threads of the threaded post 22 extend to proximate the first end 36, but may not extend all the way to the first end 36. This provides a stop mechanism 41 to prevent the indexed movable wall 14 from moving beyond the first end 36 and disengaging from the threaded post 22. Alternatively, other stops, such as a projection, may be provided at the end of the threaded post 22.

As shown in FIGS. 2, 5 and 6, the indexed movable wall 14 is configured to closely approximate the configuration of the side wall 28 of the container body 16. This allows the outer wall 26 of the indexed movable wall 14 to be positioned in close proximity to the side wall 28, thereby preventing the spreadable food 8 from moving between the outer wall 26 and the side wall 28, while allowing the indexed movable wall 14 to move relative to the side wall 28. The indexed movable wall 14 includes a threaded central opening 40 proximate the center thereof. The opening 40 is shaped and sized to receive the threaded post 22 therethrough, such that as the threaded post 22 is rotated, the threads cooperate with the walls of the opening 40 to force the indexed movable wall 14 between the first position and the second position.

In use, when the user desires additional spreadable food 8 to be forced toward the first end 18 of the container body 16, the base 20 is rotated by the user in the direction indicated by Arrow A in FIG. 2. This causes the indexed mechanism and the threaded post 22 to be rotated accordingly. When the base 20 and threaded post 22 are rotated in the appropriate direction, the indexed movable wall 14 is moved toward the first end 18 of the container body 16 (as represented by Arrow B in FIG. 2). Movement of the indexed movable wall 14 toward the first end 18 of the container body 16 moves the stored spreadable food 8 in a similar direction. As the base 20 is rotated, the indexed movable wall 14 continues to move toward the first end 18 of the container body 16. This continues until the indexed movable wall 14 engages the stop mechanism 41 (second position), which prevents further movement of the movable wall 14 toward the first end 18 of the container body 16.

Once the indexed movable wall 14 engages the stop mechanism 41, the indexed movable wall 14 is prevented from further upward motion. Therefore, continued turning of the base 20 results in the threaded post 22 turning independently of the indexed movable wall 14 or the indexed movable wall 14 spinning with the screw mechanism. In either case, the indexed movable wall 14 is not advanced toward the first end 18 of the container body 16.

The indexed movable wall 14 of the present dispensing package 10 works in conjunction with the side wall 28 of the container body 16 to provide a type of seal between the outer wall 26 of the indexed movable wall 14 and the side wall 28 of the container body 16. As many spreadable food items are manufactured and processed in a liquid form, the close proximity of the outer wall 26 of the indexed movable wall 14 to the side wall 28 prevents the less viscous spreadable food from flowing or moving beyond the indexed movable wall 14. This also prevents leakage of the spreadable food during transportation and distribution.

The indexed movable wall 14 is provided with an upper surface 42 facing the first end 18 of the container body 16 and a lower surface 44 facing the second end 30 of the container body 16. Proximate the entire periphery of the upper surface 42 of the indexed movable wall 14 is a raised portion 43, as best shown in FIG. 6. The outer wall 26 of the indexed movable wall 14 extends between the upper surface 42 and the lower surface 44.

A raised portion 43 extends from the upper surface 42 of the indexed movable wall 14 toward the first end 18 of the container body 16. The raised portion 43 is positioned adjacent the side wall 28 of the container body 16. As best shown in FIG. 6, the outer surface of the raised portion 43 extends from and is essentially a continuation of the outer wall 26. An inner surface of the raised portion 43 slopes inward, such that the raised portion 43 has a generally triangular cross section. The purpose of the raised portion 43 is to remove the spreadable food 8 from the side wall 28 of the container body 16 as the indexed movable wall 14 is moved from the first position to the second position, as will be more fully discussed. Therefore, the raised portion can have many different configurations while still accomplishing its purpose.

The formation of a secure seal between the outer wall 26 of the indexed movable wall 14 and the side wall 28 of the container body 16 may be achieved by the provision of a sealing bead 54 along the outer wall 26 of the indexed movable wall 14 adjacent the lower surface 44 of the indexed movable wall 14, as best shown in FIG. 2. The sealing bead 54 works in conjunction with an offset portion 56 of the side wall 28 of the container body 16 to form a secure seal.

Accordingly, the container body 16 includes a first inner perimeter extending form the first end 18 of the container body 16 and a second inner perimeter adjacent the second end 30 of the container body 16, wherein the first inner perimeter is slightly larger than the second inner perimeter. The second inner perimeter is created by forming or molding the container body 16 such that the side wall 28 of the container body 16 is offset adjacent the second end 30 of the container body 16.

The sealing bead 54 of the indexed movable wall 14 is shaped and dimensioned to securely engage the offset portion 56 of the container body 16 when the indexed movable wall 14 is in the first or fully retracted position adjacent the second end 30 of the container body 16 (see FIG. 2). The sealing bead 54 forms a compression seal with the inner wall 24 of the container body 16 at the offset portion 56 of the container body 16 to seal the space between the outer wall 26 of the indexed movable wall 14 and the inner wall 24 of the container body 16. As container body 16 is used over time, sealing bead 54 sets to the shape and dimensions of the inner wall 24 of the container body 16.

When the indexed movable wall 14 is in its first or fully retracted position, and the sealing bead 54 forms a compression seal with the offset portion 56 of the container body 16, the dispensing package 10 may be filled with the spreadable food 8 in a conventional manner, without worries that the spreadable food 8 will leak between the outer wall 26 of the indexed movable wall 14 and the inner wall 24 of the container body 16 during manufacture and transportation. In summary, the indexed movable wall 14 and sealing bead 54 are shaped such that the sealing bead 54 engages the inner wall 24 of the container body 16 adjacent the second end 30 of the container body 16 to form a seal permitting liquid filling of the dispensing package. The use of the seal also provides protection of the spreadable food 8 during transportation and distribution. The seal prevents leakage and product tampering. While the use of the sealing bead 54 is described, the entire container or selected portions thereof may be wrapped in plastic to provide protection against product tampering, thereby eliminating the need for seal bead 54.

When a user or consumer first desires to use the dispensing package 10 to move spreadable food 8 toward the first end 18, the consumer turns the base 20, causing the indexed movable wall 14 to move toward the first end 18. This causes the sealing bead 54 to be moved from the offset portion 56 of the container body 16. This causes the sealing bead 54 to quickly disengage from the side wall 28 of container body 16 to provide a free-floating indexed movable wall 14.

The sealing bead 54 only slightly engages the offset portion 56. As a result, only limited pressure must be applied before the indexed movable wall 14 is moved toward the first end 18 of the container body 16, and the sealing bead 54 is moved above the offset portion 56. Once the sealing bead 54 moves above the offset portion 56 of the container body 16, the sealing bead 54 remains set to the shape and dimensions of the offset portion 56, and does not contact the side wall 28 of the container body 16 as the indexed movable wall moves from the first position to the second position.

As the indexed movable wall 14 is advanced toward the first end 18 of the container body 16, the raised portion 43 engages spreadable food 8 that is in contact with the inner wall 24 of the container body 16. The raised portion 43 causes the spreadable food 8 to be removed from the side wall 28. The slope of the inner surface of the raised portion 43 causes the removed spreadable food 8 to be moved toward the center of the indexed movable wall 14, away from the side wall 28. This moves the spreadable food 8 to a location easily accessible by the user, allowing the user to access and use the spreadable food 8, rather than permitting the spreadable food 8 to adhere to the side wall 28. In addition, the removal of the spreadable food 8 from the side wall 28 in this manner prevents any spreadable food 8 from being trapped between the side wall 28 and the outer wall 26 of the movable indexed wall 14, which in turn allows the outer wall 26 to continue to move properly with respect to the side wall 28.

In the embodiment shown, the consumer removes the lid 70 from the container body 16 to access the spreadable food 8 therein. The consumer then inserts a knife or similar utensil through the first end 18 to remove spreadable food 8 from the dispensing package 10. The process of removing spreadable food 8 from the dispensing package is relatively easy and neat when spreadable food 8 is proximate the first end 18. However, in traditional jars, the process of removing the spreadable food is made more difficult and messier when the spreadable food proximate the top surface of the jar has been removed and only spreadable food proximate the bottom surface of the jar remains. With these prior art jars, the user would be required to insert the entire length of the knife into the jar in order to reach the spreadable food at the bottom of the jar. This required that portions of the user's hand would be inserted into the container body in order to access the spreadable food, causing the user's hand to be dirtied and causing contamination to the spreadable food.

This problem is averted in the present invention. As spreadable food 8 is removed from the dispensing package 10, the consumer turns the base 20, as necessary, to advance the movable indexed wall 14 and the spreadable food 8 toward the first end 18 of the container body 16. This allows spreadable food 8 always to be provided proximate the first end 18 of the dispensing package 10. In particular, the spreadable food 8 is always positioned within reach of the knife blade which is inserted into the container body 16. This allows the handle of the knife and the user's hand to be positioned outside of the container body 16. Consequently, the user's hand will not make contact with the spreadable food 8 in the container, thereby keeping the user's hand clean and preventing germs from the user's hand from contaminating the spreadable food 8 in the container.

The use of the indexing member 12 which protrudes only partially into the container body 16 is beneficial. As the indexing member 12 does not protrude into the area of the container body 16 into which the user properly inserts only the blade of the knife and not the handle, no part of the indexing mechanism 12 will be contacted by the knife. If the indexing member 12 extended further toward the first end 18 of the container body 16, the indexing member 12 would interfere with the user's dispensing the spreadable food 8 with his/her knife. Therefore, in order to allow the user to properly access the spreadable food 8, the indexing member 12 cannot extend to proximate the first end 18 of the container 16. The purpose of this container is not to dispense the spreadable food 8 directly from the container to another food product; it is to move the spreadable food 8 toward the first end 18 of the container so that the user can easily and neatly access the spreadable food 8 with a knife or other utensil.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or spreadable food to the teachings of the invention without departing from the essential scope thereof. Therefore, it is intended that the invention not be limited to the particular embodiment disclosed as the best mode contemplated for carrying out this invention, but rather, is intended to cover all embodiments, all modifications and alternate constructions falling within the spirit and scope of the invention as defined in the appended claims.

1. A spreadable food dispensing package comprising:
a container body having spreadable food positioned therein, the container body having a first end with an opening through which the spreadable food is removed;
a base attached to the container body and rotatable relative to the container body;
an indexing mechanism attached to the base, the indexing mechanism extending from the base toward the first end of the container body;
an indexed movable wall which cooperates with the indexing mechanism;
whereby as the base is rotated relative to the container body, the indexing mechanism is moved causing the indexed movable wall to move from a first position proximate the base to a second position which is spaced from the base and from the first end of the container body, forcing the spreadable food to move toward the first end of the container body to allow a consumer to easily remove the spreadable food from the container body with a utensil.

2. The spreadable food dispensing package as recited in claim 1 wherein the indexing mechanism is a post with threads positioned thereon which cooperate with the indexed movable wall to move the wall from the first position to the second position.

3. The spreadable food dispensing package as recited in claim 1 wherein a recess is provided proximate a second end of the container body, the recess extending about the periphery of the container body, the recess cooperating with a projection of the base to prevent the removal of the base from the container body, while permitting the base to rotate relative to the connector body.

4. The spreadable food dispensing package as recited in claim 1 wherein the indexing mechanism has a free end which is spaced from the base and spaced from the first end of the container body, the free end of the indexing mechanism having a stop mechanism thereon, the stop mechanism preventing the indexed movable wall from moving past the second position, thereby providing an unobstructed portion of the container body above the indexed movable wall in which a utensil can be positioned without engaging the indexing mechanism.

5. The spreadable food dispensing package as recited in claim 4 wherein the free end of the indexing mechanism is spaced approximately equidistant from the first end of the container body and the base.

6. The spreadable food dispensing package as recited in claim 1 wherein the base and the indexing mechanism are one unitary mechanism.

7. The spreadable food dispensing package as recited in claim 1 wherein the indexed movable wall has a raised portion extending from an upper surface thereof toward the first end of the container body, the raised portion being positioned proximate the periphery of the indexed movable wall, whereby as the indexed movable wall is moved from the first position to the second position, the raised portion cooperates with an inner wall of the container portion to remove the spreadable food from the inner wall.

8. The spreadable food dispensing package as recited in claim 1 wherein a seal is provided between the indexed movable wall and an inner wall of the container body when the indexed movable wall is in the first position.

9. A spreadable food dispensing package comprising:
a container body having spreadable food positioned therein, the container body having a first end with an opening through which the spreadable food is removed;
a base attached to the container body and rotatable relative to the container body;
an indexing mechanism attached to the base, the indexing mechanism extending from the base toward the first end of the container body;
an indexed movable wall which cooperates with the indexing mechanism, the indexed movable wall having a raised portion extending from an upper surface thereof toward the first end of the container body, the raised portion being positioned proximate the periphery of the indexed movable wall;
whereby as the indexed movable wall is moved from a first position proximate the base to a second position which is spaced from the base, the raised portion cooperates with an inner wall of the container portion to remove the spreadable food from the inner wall.

10. The spreadable food dispensing package as recited in claim 9 wherein the indexing mechanism is a post with threads positioned thereon which cooperate with the indexed movable wall to move the wall from the first position to the second position.

11. The spreadable food dispensing package as recited in claim 9 wherein a recess is provided proximate a second end of the container body, the recess extending about the periphery of the container body, the recess cooperating with a projection of the base to prevent the removal of the base from the container body, while permitting the base to rotate relative to the connector body.

12. The spreadable food dispensing package as recited in claim 9 wherein the indexing mechanism has a free end which is spaced from the base and spaced from the first end of the container body, the free end of the indexing mechanism having a stop mechanism thereon, the stop mechanism preventing the indexed movable wall from moving past the second position, which is spaced from the base and from the first end of the container body, thereby providing an unobstructed portion of the container body above the indexed movable wall in which a utensil can be positioned without engaging the indexing mechanism.

13. The spreadable food dispensing package as recited in claim 12 wherein the free end of the indexing mechanism is spaced approximately equidistant from the first end of the container body and the base.

14. The spreadable food dispensing package as recited in claim 9 wherein the base and the indexing mechanism are one unitary mechanism.

15. The spreadable food dispensing package as recited in claim 9 wherein a seal is provided between the indexed movable wall and an inner wall of the container body when the indexed movable wall is in the first position.

16. A spreadable food dispensing package comprising:
a container body having spreadable food positioned therein, the container body having a first end with an opening through which the spreadable food is removed;
a base attached to the container body and rotatable relative to the container body;
an indexing mechanism attached to the base, the indexing mechanism extending from the base toward the first end of the container body;
an indexed movable wall which cooperates with the indexing mechanism, the indexed movable wall having a raised portion extending from an upper surface thereof toward the first end of the container body, the raised portion being positioned proximate the periphery of the indexed movable wall;
whereby as the base is rotated relative to the container body, the indexing mechanism is moved causing the indexed movable wall to move from a first position proximate the base to a second position which is spaced from the base and from the first end of the container body, causing the raised portion to cooperate with an inner wall of the container portion to remove the spreadable food from the inner wall, forcing the spreadable food to move toward the first end of the container body to allow a consumer to easily remove the spreadable food from the container body with a utensil.

17. The spreadable food dispensing package as recited in claim 16 wherein the indexing mechanism is a post with threads positioned thereon which cooperate with the indexed movable wall to move the wall from the first position to the second position.

18. The spreadable food dispensing package as recited in claim 16 wherein a recess is provided proximate a second end of the container body, the recess extending about the periphery of the container body, the recess cooperating with a projection of the base to prevent the removal of the base from the container body, while permitting the base to rotate relative to the connector body.

19. The spreadable food dispensing package as recited in claim 16 wherein the indexing mechanism has a free end which is spaced from the base and spaced from the first end of the container body, the free end of the indexing mechanism having a stop mechanism thereon, the stop mechanism preventing the indexed movable wall from moving past the second position, thereby providing an unobstructed portion of the container body above the indexed movable wall in which a utensil can be positioned without engaging the indexing mechanism.

20. The spreadable food dispensing package as recited in claim 16 wherein a seal is provided between the indexed movable wall and an inner wall of the container body when the indexed movable wall is in the first position.
